(19) United States
(12) Patent Application Publication
(10) Pub. No.: US 2022/0282838 A1
(43) Pub. Date: Sep. 8, 2022

(54) SLUG FLOW ELIMINATION IN MULTIPHASE FLOW PIPELINES USING MULTIPLE STATIC MIXERS

(71) Applicant: SAUDI ARABIAN OIL COMPANY, Dhahran (SA)

(72) Inventors: Samusideen Adewale Salu, Dhahran (SA); Ali A. Al-Yami, Dhahran (SA); Mohamed A. Soliman, Dhahran (SA)

(73) Assignee: SAUDI ARABIAN OIL COMPANY, Dhahran (SA)

(21) Appl. No.: 17/193,685

(22) Filed: Mar. 5, 2021

(51) Int. Cl. F17D 1/20; F17D 1/00; F16L 55/46; B01F 5/06

(52) U.S. Cl. CPC F17D 1/20; F17D 1/005; F16L 55/46; B01F 5/0608; B01F 5/0644; F16L 2101/12

(57) ABSTRACT

A system includes a plurality of static mixers. Each static mixer has an internal cylinder defining a central orifice for passage of the multi-phase fluid. The internal cylinder has an inlet side and an outlet side. The inlet side of the internal cylinder has a plurality of inlet channels, and the outlet side of the internal cylinder has a plurality of outlet channels. The multi-phase fluid enters the inlet side to be mixed in the central orifice and is expelled through the outlet side. The plurality of static mixers are fixedly disposed along the pipeline at a predetermined number of locations, spaced a predetermined distance apart, to mix the multi-phase fluid and prevent formation of the adverse flow regimes.

### BACKGROUND

Hydrocarbon transport systems are used to transport fluids to and from various production and refining operations. Hydrocarbon transport systems use conduits such as pipelines to transport the fluids over long distances. Herein, the term “fluid” is used to describe a substance that has no fixed shape and yields easily to external pressure, and, as such, the term “fluid” may be referring to gases, liquids, or a combination of both. The fluids that are transferred within the hydrocarbon transport systems may be crude oil/wild crude, dry gas, wet gas, water, etc.

Crude oil, in particular, is unrefined hydrocarbon and may consist of hydrocarbon liquids, salty water, oil-water emulsions, and/or gases. When the fluid flowing through the pipeline consists of a liquid phase and a gaseous phase, then the fluid is a multi-phase fluid. Multi-phase fluid flow in a pipeline is prone to forming adverse flow regimes that may damage and effect the integrity and reliability of a reception facility located at the end of a pipeline. As such, the ability to prevent the formation of adverse flow regimes in a pipeline is beneficial.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

The present disclosure presents, in one or more embodiments, a system and method for preventing adverse flow regimes of a multi-phase fluid from forming in a pipeline. In general, and in one embodiment, the system has a plurality of static mixers. Each static mixer has an internal cylinder defining a central orifice for passage of the multi-phase fluid. The internal cylinder has an inlet side and an outlet side. The inlet side of the internal cylinder has a plurality of inlet channels, and the outlet side of the internal cylinder has a plurality of outlet channels. The multi-phase fluid enters the inlet side to be mixed in the central orifice and is expelled through the outlet side. The plurality of static mixers are fixedly disposed along the pipeline at a predetermined number of locations, spaced a predetermined distance apart, to mix the multi-phase fluid and prevent formation of the adverse flow regimes.

In further embodiments, a method for preventing adverse flow regimes of a multi-phase fluid from forming in a pipeline includes determining, using a flow simulator, a number of locations for a plurality of static mixers, configured to be installed along a pipeline, and a distance between the plurality of static mixers. Installing the plurality of static mixers along the pipeline at the number of locations spaced the distance apart where the plurality of static mixers each have an internal cylinder defining a central orifice, a plurality of inlet channels, and a plurality of outlet channels. Adjusting the internal cylinder to change an angle of the plurality of inlet channels and the plurality of outlet channels to optimize a degree of mixing and a pressure loss. Flowing the multi-phase fluid through the pipeline where the multi-phase fluid enters each static mixer through the plurality of inlet channels. The multi-phase fluid is mixed in the central orifice to prevent formation of the adverse flow regimes, and the multi-phase fluid is expelled through the plurality of outlet channels.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A-1G show various flow regimes in accordance with one or more embodiments.

FIG. 2 shows an apparatus in accordance with one or more embodiments.

FIG. 3 shows a system in accordance with one or more embodiments.

FIG. 4 shows a flowchart in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Embodiments disclosed herein relate to a system capable of preventing slug flow pattern from occurring in wild crude and natural gas pipelines under any of possible operating scenarios. The system is capable of converting segregated flow regimes (stratified, annular, intermittent/slug) to dispersed/bubble flow or a mist flow regime. Embodiments disclosed herein disperse and mix liquid and gas portions of a segregated flow pattern before transition into slug flow. The system is also capable of breaking small liquid slugs into bubble flow or mist flow pattern as the case may be before they could coalesce and grow into longer slugs of full-scale slug flow pattern. Embodiments disclosed herein break and disperse slugs within the pipeline far before they reach production traps.

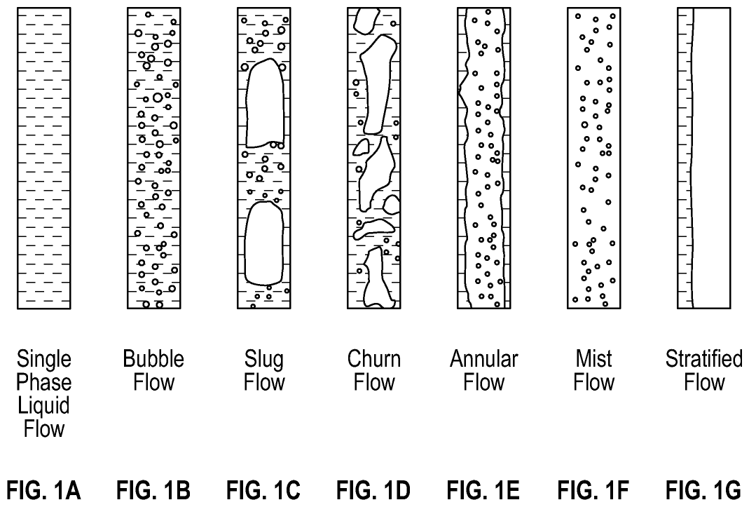

FIG. 1A-1F depict various flow regimes that may be seen in a pipeline. A flow regime is a description or categorization of the flow structure of a fluid. FIG. 1A shows a single-phase flow regime, in particular, a single-phase liquid flow regime. The flow regime depicted in FIG. 1A is not considered an adverse flow regime and does not have the potential to form into an adverse flow regime. FIG. 1B depicts a bubble flow regime. In a bubble flow regime, the gaseous phase is dispersed in the liquid phase as bubbles. The flow regime depicted in FIG. 1B is not considered an adverse flow regime but does have the potential to evolve into an adverse flow regime.

FIG. 1C depicts a slug flow regime which is considered an adverse flow regime. A slug flow regime consists of intermittent slugs of liquid followed by longer gas bubbles. FIG. 1D depicts a churn flow regime which is considered an adverse flow regime. A churn flow regime typically only occurs in vertical pipelines and consists of irregular slugs of gas moving up the center of the pipeline, usually carrying droplets of liquid. FIG. 1E depicts an annular flow regime which is considered an adverse flow regime. An annular flow regime is characterized by a lighter fluid (such as a gas) flowing through the center of the pipeline and a heavier fluid (such as a liquid) contained as a thin film along the pipeline walls.

FIG. 1F depicts a mist flow regime. In a mist flow regime, the liquid phase is dispersed in the gaseous phase as droplets or “mist.” The flow regime depicted in FIG. 1F is not considered an adverse flow regime but does have the potential to evolve into an adverse flow regime. FIG. 1G depicts a stratified flow regime which is considered an adverse flow regime. In a stratified flow regime, the liquid phase and the gaseous phase are separated with the liquid flowing in a distinct stream along the bottom of the pipeline. Preventing adverse flow regimes from forming in a pipeline and/or eliminating already present adverse flow regimes within a pipeline is important as the presence of adverse flow regimes may cause damage to the pipeline and effect the reliability and integrity of the pipeline and the pipeline's reception facilities. Accordingly, embodiments disclosed herein present apparatuses and methods for preventing (or eliminating) adverse flow regimes from forming in a pipeline transporting a multi-phase fluid.

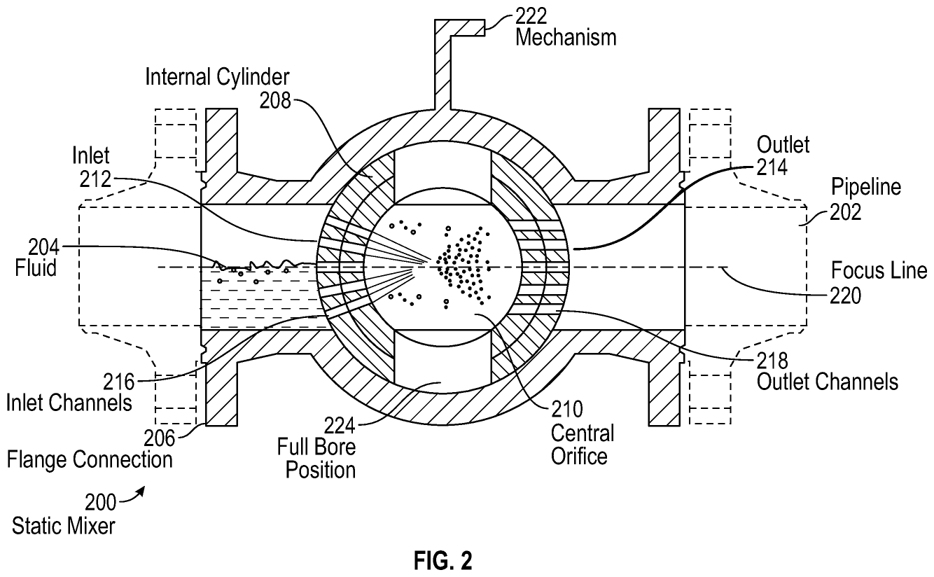

FIG. 2 depicts a static mixer (200) configured to be installed along a pipeline (202), carrying a multi-phase fluid (204), to prevent the formation of adverse flow regimes and to eliminate any adverse flow regimes that may be present. In one or more embodiments, the multi-phase fluid (204) includes a gas phase and a liquid phase. The static mixer (200) may be installed along the pipeline (202) using a flange connection (206). The pipeline (202) may be made of any suitable material, such as steel, that is able to withstand the pressures and temperatures of the fluid (204). In other embodiments, the static mixer (200) may be installed along the pipeline (202) by welding the static mixer (200) to pipeline (202) segments. The static mixer (200) includes an internal cylinder (208) defining a central orifice (210) for passage of the multi-phase fluid (204). The internal cylinder (208) may be made of any suitable material such as steel, that is able to withstand the pressures and temperatures of the fluid (204). The internal cylinder (208) has an inlet (212) side and an outlet (214) side. The inlet (212) side of the internal cylinder (208) has a plurality of inlet channels (216). The outlet (214) side of the internal cylinder (208) has a plurality of outlet channels (218). In other embodiments, the static mixer (200), as depicted in FIG. 2, has five inlet channels (216) and five outlet channels (218).

The inlet channels (216) are angled towards a focus line (220), and the outlet channels (218) are horizontal and parallel to the focus line (220). The focus line (220) is an imaginary line used as a common point in which to direct the inlet channels (216). The focus line (220) is depicted in FIG. 2 as passing directly through the center of the pipeline (202), but the focus line (220) may be located anywhere. The location of the focus line (220) and the number of inlet channels (216) and outlet channels (218) are determined using the known, assumed, and/or calculated fluid properties and composition of the multi-phase fluid (204) flowing through the pipeline (202). The fluid properties used may include fluid velocity, gas hold up, liquid holdup, fluid densities, flowrate, etc.

The multi-phase fluid (204) flows from the pipeline (202) into the central orifice (210) through the inlet channels (216). The multi-phase fluid (204) is mixed in the central orifice (210) due to the inlet channels (216) being angled. The multi-phase fluid (204) is expelled through the outlet channels (218). The mixing of the multi-phase fluid (204) in the central orifice (210) is the act that prevents adverse flow regimes from forming or disperses already formed adverse flow regimes. In one or more embodiments, a slug flow regime may enter the static mixer (200), through the inlet channels (216), to be mixed in the central orifice (210). The mixing may turn the slug flow regime into a bubble flow regime, and the bubble flow regime may exit the central orifice (210) through the outlet channels (218) to be carried elsewhere by the pipeline (202).

In further embodiments, a mechanism (222) is fixed to the internal cylinder (208) of the static mixer (200). The mechanism (222) is used to rotate the internal cylinder (208). The internal cylinder (208) may be rotated to change the angle of the inlet channels (216) and the outlet channels (218) to optimize the degree of mixing and the pressure losses. The internal cylinder (208) may also be rotated to a full-bore position (224) in which the inlet channels (216) and the outlet channels (218) are removed from the path of the fluid (204) flow, and there are no obstructions located within the static mixer (200) such that there is a smooth transition between the pipeline (202) and the static mixer (200). The mechanism (222) may be a physical mechanism (222), as depicted in FIG. 2, or an electronic mechanism. The physical mechanism (222) may be a lever such as seen on a ball valve. The electronic mechanism may be controlled by a computer processor to rotate the internal cylinder (208) to the required position.

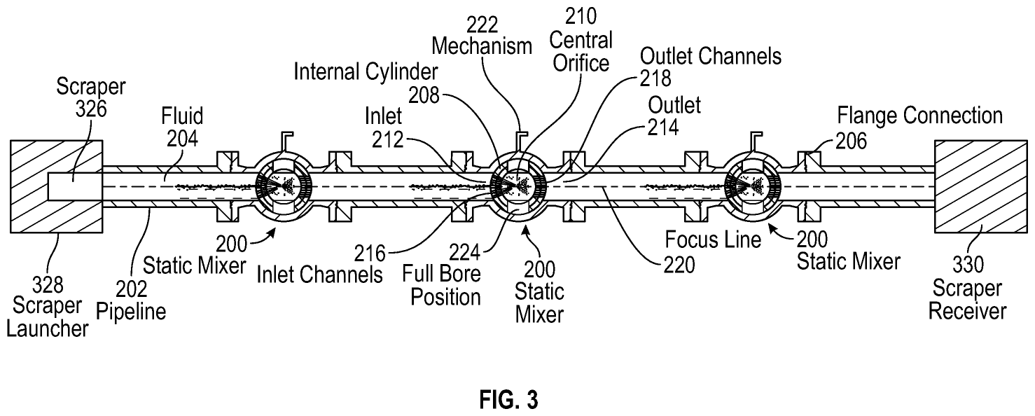

FIG. 3 shows a system for preventing adverse flow regimes of a multi-phase fluid (204) from forming in a pipeline (202) and eliminating already present adverse flow regimes in the pipeline (202). The components of the system depicted in FIG. 3 that are identical/similar to the components of the system described in FIG. 2 are not re-described for purposes of readability and have the same functions described above. In the embodiment of FIG. 3, a plurality of static mixers (200) are fixed along the pipeline (202) at a predetermined number of locations spaced a pre-determined distance apart to mix the multi-phase fluid (204). The predetermined number of locations of the plurality of static mixers (200) and the predetermined distance between the plurality of static mixers (200) are determined by flow simulators such as OLGA, KGT-LedaFlow, PIPESIM, PIPEPHASE, etc.

In one or more embodiments, the system of FIG. 3 is depicted as having three static mixers (200) spaced at an equidistance apart. The multi-phase fluid (204) is depicted as entering the static mixers (200) as an adverse flow regime and then exiting the static mixers (200) as a non-adverse flow regime. However, those skilled in the art will appreciate that the multi-phase fluid (204) may never form adverse flow regimes and/or the multi-phase fluid (204) may enter the static mixers (200) prior to adverse flow regimes occurring, without departing from the scope of this disclosure. Further, those skilled in the art will appreciate that while 3 static mixers are shown in FIG. 3, spaced equidistant apart, any suitable number of mixers may be employed at equal or unequal distances apart, without departing from the scope disclosed herein.

Further, as noted above, the appropriate numbers of the special flow mixing device (multiphase static flow mixers) along pipelines at appropriate locations that will be effective for a particular pipeline system is determined by rigorous multiphase flow simulators such as OLGA and Computational Fluid Dynamics (CFD). These flow simulators are known to those of ordinary skill in the art and are capable of accurately predicting multiphase flow patterns in pipelines. The prediction from this type of flow simulation software is utilized by embodiments disclosed herein to determine where the adverse flow regimes (such as slug flow) may be formed along the pipeline and to establish the appropriate location to install static mixers that will break the adverse flow regimes (or slugs). One example of such a static mixer is an inline mixer used in mixing chemicals and fresh water with crude in dehydration/desalting operations. With minor modification, such an inline mixer is capable of achieving the objective of this disclosure.

The system of FIG. 3 further includes a scraper (326), a scraper launcher (328), and a scraper receiver (330). The scraper (326) is a mechanical device, such as a pig, that may be launched through the pipeline (202). The scraper (326) mechanically removes materials such as scale and solids buildup from the interior walls of the pipeline (202). The scraper launcher (328) launches the scraper (326) through the pipeline (202) and the scraper receiver (330) receives the scraper (326). The scraper launcher (328) may also act as a scraper receiver (330), and the scraper receiver (330) may also act as a scraper launcher (328). The mechanism (222) on the static mixers (200) may rotate the internal cylinder (208) to the full-bore position (224) which allows the scraper (326) to pass through the static mixers (200) without having to remove the static mixer (200) from the pipeline (202).

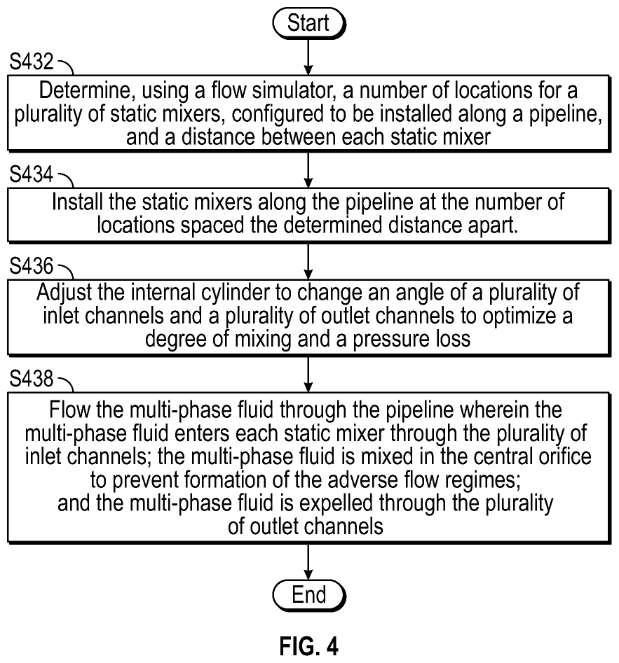

FIG. 4 depicts a flowchart in accordance with one or more embodiments. More specifically, FIG. 4 illustrates a method for preventing adverse flow regimes of a multi-phase fluid (204) from forming in a pipeline (202) and eliminating already present adverse flow regimes within the pipeline (202). Further, one or more blocks in FIG. 4 may be performed by one or more components as described in FIG. 2 or FIG. 3. While the various blocks in FIG. 4 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

Initially, the expected or measured fluid properties of the multi-phase fluid (204) flowing through the pipeline (202) are entered into a flow simulator. The flow simulator may be any commercially available flow simulator such as OLGA, KGT-LedaFlow, PIPESIM, PIPEPHASE, etc. The flow simulator may determine which locations along the pipeline (202) are likely to experience adverse flow regimes such as slug flow, churn flow, annular flow, and stratified flow. Using this information from the flow simulator, a number of locations for a plurality of static mixers (200) and a distance between each static mixer (200) are determined (S432). The static mixers (200) are installed along the pipeline (202) at the number of locations spaced the determined distance apart (S434).

Specifically, expanding on S434, the static mixers (200) may be installed along the pipeline (202) using flange connections (206) or by welding the static mixers (200) to the pipeline (202) segments. The static mixers (200) each have an internal cylinder (208) defining a central orifice (210). Each internal cylinder (208) has a plurality of inlet channels (216) and outlet channels (218). The inlet channels (216) are angled towards a focus line (220) and the outlet channels (218) are horizontally parallel to each other and the focus line (220). A mechanism (222), such as a lever, is fixed to the internal cylinder (208). Using the mechanism (222), the internal cylinder (208) is adjusted to change the angle of the inlet channels (216) and the outlet channels (218) to optimize the degree of mixing and the pressure loss (S436).

The multi-phase fluid (204) flows through the pipeline (202), and the fluid (204) enters the central orifice (210) of each static mixer (200) through the inlet channels (216). The multi-phase fluid (204) is mixed in the central orifice (210) to prevent the formation of the adverse flow regimes or to eliminate already present adverse flow regimes. The fluid (204) is mixed due to the inlet channels (216) being angled to the focus line (220). The multi-phase fluid (204) is expelled through the outlet channels (218) (S438) as a straightened flow due to the outlet channels (218) being horizontal and parallel to each other.

The prevention of adverse flow regimes using the above method improves the mechanical reliability and integrity of the pipeline (202) and the pipeline's arrival facilities and allows for a substantial reduction in gas flaring which allows for conservation of production gas. A reduction in gas flaring also improves the reliability and life span of flare tips and reduces the maintenance costs of replacing and repairing the flares. This method also reduces the frequency of pipeline (202) scraping as the corrosive water and sludge will be mixed into the fluid (204) using the static mixers (200). The elimination of adverse flow regimes also eliminates process upsets that are often caused by rapid fluctuations in pressure and flow rates within the pipeline (202). This reduces production interruptions and enhances maximum sustainable capacity of the pipeline (202). The static mixer (200) as described in FIG. 2 allows for a reduction in pressure drop along the pipeline (202), and, as such, production volumes and flow rates may be increased within the pipeline (202). The improvement of fluid (204) flow within the pipeline (202) enhances the effectiveness of drag reducing agents and reduces the amount of corrosion inhibitor required.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed:

1. A system for preventing adverse flow regimes of a multi-phase fluid from forming in a pipeline, the system comprising:
a plurality of static mixers each comprising:
an internal cylinder defining a central orifice for passage of the multi-phase fluid comprising an inlet side and an outlet side;
the inlet side of the internal cylinder comprising a plurality of inlet channels; and
the outlet side of the internal cylinder comprising a plurality of outlet channels, and
wherein the multi-phase fluid enters the inlet side to be mixed in the central orifice and is expelled through the outlet side,
wherein the plurality of static mixers are fixedly disposed along the pipeline at a predetermined number of locations, spaced a predetermined distance apart, to mix the multi-phase fluid and prevent formation of the adverse flow regimes.

2. The system of claim 1,
wherein the plurality of inlet channels are angled towards a focus line.

3. The system of claim 2,
wherein the plurality of outlet channels are parallel to the focus line.

4. The system of claim 1, further comprising:
a scraper;
a scraper launcher; and
a scraper receiver.

5. The system of claim 4, further comprising:
a mechanism used to rotate the internal cylinder of the plurality of static mixers to a full-bore position such that the scraper passes through the internal cylinder.

6. The system of claim 5,
wherein the mechanism is used to adjust the internal cylinder to change an angle of the plurality of inlet channels and the plurality of outlet channels to optimize a degree of mixing and a pressure loss.

7. The system of claim 1,
wherein the multi-phase fluid is comprised of a gas phase and a liquid phase.

8. The system of claim 7,
wherein the adverse flow regimes comprise at least one of: slug flow, churn flow, and annular flow.

9. The system of claim 1,
wherein the predetermined number of locations of the plurality of static mixers and the predetermined distance between the plurality of static mixers are determined by a flow simulator.

10. The system of claim 1,
wherein the plurality of static mixers are fixed along the pipeline using flange connections.

11. The system of claim 1,
wherein the plurality of static mixers are fixed along the pipeline by welding the plurality of static mixers to the pipeline.

12. A method for preventing adverse flow regimes of a multi-phase fluid from forming in a pipeline, the method comprising:
determining, using a flow simulator, a number of locations for a plurality of static mixers, configured to be installed along a pipeline, and a distance between the plurality of static mixers;
installing the plurality of static mixers along the pipeline at the number of locations spaced the distance apart wherein the plurality of static mixers each comprise an internal cylinder defining a central orifice, a plurality of inlet channels, and a plurality of outlet channels;
adjusting the internal cylinder to change an angle of the plurality of inlet channels and the plurality of outlet channels to optimize a degree of mixing and a pressure loss; and
flowing the multi-phase fluid through the pipeline wherein the multi-phase fluid enters each static mixer through the plurality of inlet channels; the multi-phase fluid is mixed in the central orifice to prevent formation of the adverse flow regimes; and the multi-phase fluid is expelled through the plurality of outlet channels.

13. The method of claim 12,
wherein the plurality of inlet channels are angled towards a focus line.

14. The method of claim 13,
wherein the plurality of outlet channels are parallel to the focus line.

15. The method of claim 12, further comprising:
a scraper;
a scraper launcher; and
a scraper receiver.

16. The method of claim 15, further comprising:
a mechanism used to rotate the internal cylinder of the plurality of static mixers to a full-bore position such that the scraper passes through the internal cylinder.

17. The method of claim 12,
wherein the multi-phase fluid is comprised of a gas phase and a liquid phase.

18. The method of claim 17,
wherein the adverse flow regimes comprise at least one of: slug flow, churn flow, and annular flow.

19. The method of claim 12,
wherein the plurality of static mixers are fixed along the pipeline using flange connections.

20. The method of claim 12,
wherein the plurality of static mixers are fixed along the pipeline by welding the plurality of static mixers to the pipeline.
